(19) United States
(12) Patent Application Publication
(10) Pub. No.: US 2023/0341197 A1
(43) Pub. Date: Oct. 26, 2023

(54) PROCESS AND APPARATUS FOR COOLING HOT OBJECTS

(71) Applicant: AUTOTECH ENGINEERING S.L., Amorebieta-Etxano, Bizkaia (ES)

(72) Inventor: Daniel PALO, Luleå (SE)

(73) Assignee: AUTOTECH ENGINEERING S.L., Amorebieta-Etxano, Bizkaia (ES)

(21) Appl. No.: 17/757,826

(22) PCT Filed: Dec. 18, 2020
(86) PCT No.: PCT/EP2020/087087

§ 371 Date: Jun. 21, 2022

(30) Foreign Application Priority Data
Dec. 20, 2019 (SE) 1951531-1

(51) Int. Cl. F28F 13/10

(52) U.S. Cl. CPC F28F 13/10; F28F 2013/001

(57) ABSTRACT

The present invention relates to a process for cooling a metal component, the process comprising the step of cooling said component in a confined space, said cooling involving cooling by means of a gas, the gas being cooled by heat exchange with a cooling surface of a heat sink inside said confined space, wherein a low frequency sound wave is provided into said confined space in order to improve heat exchange both between the gas and a cooling surface of the at least one heat sink, and between the gas and the metal component, characterised in that the cooling gas comprises at least one protective inert gas. The invention further relates to an apparatus for performing the process.

### TECHNICAL AREA

The invention relates to a process and apparatus for cooling metal components, which metal components may be used as components in automobile manufacturing.

### BACKGROUND OF INVENTION

In the manufacturing of components for example in the automobile industry the components are often processed in steps, from hot rolling, via a cooling step to a forming step and final cooling to ambient temperature. For best efficiency and to avoid losses of time, all steps should be performed quickly, and since the overall efficiency is governed by the slowest step, each step should be kept as efficient as possible.

Normally, the cooling step of cooling the detail prior to the forming step involves air cooling and is therefore the most time-consuming step. Therefore, if the time for the cooling step could be reduced, the overall time could be reduced by a multiple of the time reduction for the cooling step as each step of the process may be equally shortened.

As discussed above, air cooling is generally too slow for an efficient cooling, especially in a process where several steps are performed after each other. There are however methods of improving the rate of cooling in air cooling.

It is inter alia known to improve air cooling by means of the application of infra sound in order to increase heat exchange with the surrounding air. In SE 462 374 B a low frequency sound generator is described. This is advantageous but has hitherto not been successfully implemented in an industrial application.

A further problem associated with cooling of hot metal components is that the hot metal from for example metal sheet production will form an outer layer of oxide scale due to exposure to oxygen. The oxide scale is unwanted since it will affect later working on the metal sheets, such as subsequent forming by pressing to different shapes, often leading to cold hardening. The oxide scale then has to be removed before the pressing and cold hardening of the metal components. It would therefore be advantageous if the material could be cooled so rapidly that oxide scale build-up is reduced.

Another problem associated with cooling of hot components that are to be treated in a subsequent pressing step and in particular a pressing step including cold hardening is when the components or blanks have a thickness in the region of 4 to 7 mm. Usually when handling blanks and in particular in the automotive industry, the thickness of the sheet metal that are formed to components in turn forming the white body of a vehicle is in the region of 0.6-0.8 mm. This region of thickness allows a rapid cooling, first a cooling between the furnace and the pressing unit and then the cooling in the tools of the pressing unit. With a thicker component, there is very little natural cooling between the furnace and the pressing unit, which means that the component has a high temperature when the forming step begins. This in turn will have a negative impact on the wear of the tools of the pressing unit, leading to more frequent exchange of tools in the pressing unit and thereby higher production costs. There is thus a demand for handling also thicker metal blanks that are to be formed to components by pressing and cold hardening.

### BRIEF DESCRIPTION OF INVENTION

The aim of the present invention is to remedy the drawbacks of cooling of components, and in particular metal components. This aim is obtained with a process and an apparatus with the features of the independent patent claims. Preferable embodiments of the invention form the subject of the dependent patent claims.

According to a process for cooling a metal component, it may comprise the step of cooling said component in a confined space, where the cooling involves cooling by means of a gas, the gas being cooled by heat exchange with a cooling surface of a heat sink inside the confined space, wherein a low frequency sound wave may be provided into the confined space in order to improve heat exchange both between the gas and a cooling surface of the at least one heat sink, and between the gas and the metal component. The invention is characterised in that the cooling gas may comprise at least one protective inert gas.

The advantage with this solution is that there is a combination between rapid cooling by the cooling box and the use of inert gas, which both assist in minimizing any build-up of oxide scale on the surface of the component. This in turn minimizes or removes any treatment steps of the cooled component before for example a pressing step.

According a possible solution, the cooling gas may comprise a mixture of gases, where each gas component may have certain properties in cooling and/or scale build-up prevention. In this regard, the cooling gas may possess as good as possible heat transfer properties. This is advantageous because the aim is to have a cooling that is as rapid as possible. One advantageous solution is that the gas may comprise nitrogen. Nitrogen is both an effective gas in this application and is relatively cost-efficient in comparison with other inert gases. Also, the gas may further comprise methanol as protective component. In any event, the gas may be injected into the confined space.

According to as further aspect of the invention, the sound wave may have a frequency that preferably is lower than 50 Hz, more preferably lower than 20 Hz and according to one preferred embodiment 16 Hz.

Preferably, the sound wave may be provided from a first end of the confined space so as to propagate through the confined space and away at a second end of the confined space, opposite to the first end thereof. This may be especially beneficial if the component is a flat sheet metal blank wherein the sound wave may propagate on both sides of the blank, providing effective cooling on both sides of the blank simultaneously. In connection with this, components to be cooled in the confined space may be conveyed from a first end to a second end in a direction generally transversal to the direction of the sound wave. Here a continuous movement of components may be obtained in one direction having the standing wave propagating in the transversal direction.

The present application further comprises an apparatus for cooling a metal component by means of a gas. The apparatus may comprise a cooling box forming a confined space and provided with an opening for receiving a component to be cooled, wherein at least one heat sink is provided inside the cooling box for cooling of the gas. Further, the apparatus may include at least one infra sound pulsator arranged to provide an infra sound into the cooling box to improve heat exchange both between the gas and a cooling surface of the at least one heat sink, and between the gas and the component. It is characterised in at least one inlet in communication with the confined space, which inlet may be connected to a source of protective inert gas. As with the process mentioned above, an improved cooling and reduction of any oxide scale build-up may be prevented by the combination of infra sound cooling and the use of an inert gas, protecting the surface of the component from oxygen in the surrounding air that may otherwise affect the surface negatively.

According to a further aspect, the inner walls of the cooling box may form part of the at least one heat sink, and where flexible cooling conduits may be arranged to provide a cooling fluid to cool the heat sink. This even further increases the cooling effect and efficiency of the cooling box. In order to further improve the cooling efficiency, the at least one heat sink may be arranged with cooling flanges.

According to a further aspect of the device, the opening of the cooling box may be slit-shaped and adapted to receive a metal component to be cooled, where the component may have an elongate form, typically in the form of a plate, and wherein the apparatus may include at least one guide element adapted to guide component into and/or out from the cooling box through the opening. As a development of this design, a first and a second slit-shaped opening may be arranged at opposite sides of the cooling box, and wherein the at least one guide element may be adapted to guide the metal component into the cooling box through the first slit-shaped opening and out through the second slit-shaped opening.

Further, the guide element may consist of a pair of conveyer rolls, which are arranged at each opening, wherein the pair of conveyer rolls may be arranged to guide a metal component between them. As a further development, at least two cooling boxes may be arranged in succession wherein a component to be cooled may be transferred from one cooling box to the subsequent. With this layout, components that are longer than one cooling box may be treated and cooled in an effective way. Here the component may be conveyed through the series of cooling boxes in order to be cooled effectively. In this regard, the speed of conveyed components may be altered and in particular increased per component in the beginning of each component to be cooled and then reduced since the rear end of the component may be placed outside a cooling box for a longer period of time than a front end of the component. In order that the rear end shall not be exposed to oxygen for too long a time period, the conveyor speed is increased in the beginning and then reduced as the component is conveyed through the cooling box or boxes if several are used.

These and other aspects of, and advantages with, the present invention will become apparent from the following detailed description of the invention and from the accompanying drawings.

### BRIEF DESCRIPTION OF DRAWINGS

In the following detailed description of the invention, reference will be made to the accompanying drawings, of which

FIG. 1 is a schematic cross-sectional view of an embodiment of an apparatus for cooling hot objects;

FIG. 2 is a schematic perspective view of an alternative embodiment of an apparatus for cooling hot objects;

FIG. 3 is a schematic cross-sectional view of the cooling box shown in FIG. 2;

FIG. 4 shows a first embodiment of a pulsator to be used in the apparatus of FIGS. 1-2;

FIG. 5 shows a second embodiment of a pulsator to be used in the apparatus of FIGS. 1-2;

FIGS. 6-9 show a third embodiment of a pulsator in different working modes; and

FIG. 10 is a schematic cross-sectional view of series of cooling boxes shown in FIG. 2.

### DETAILED DESCRIPTION OF THE INVENTION

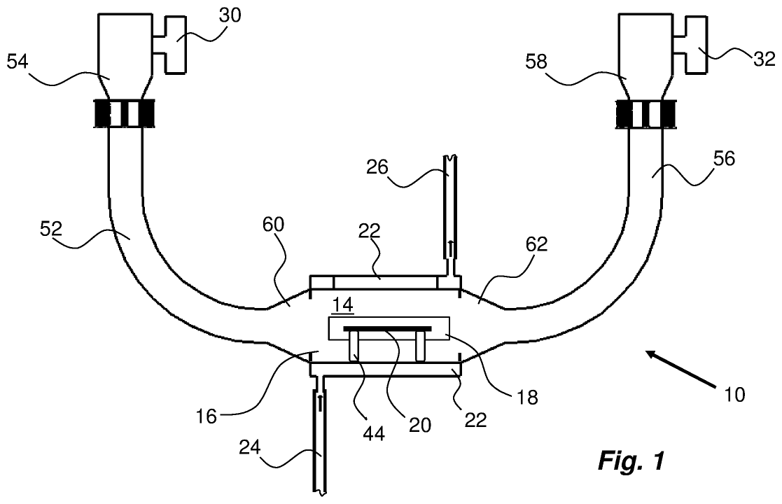

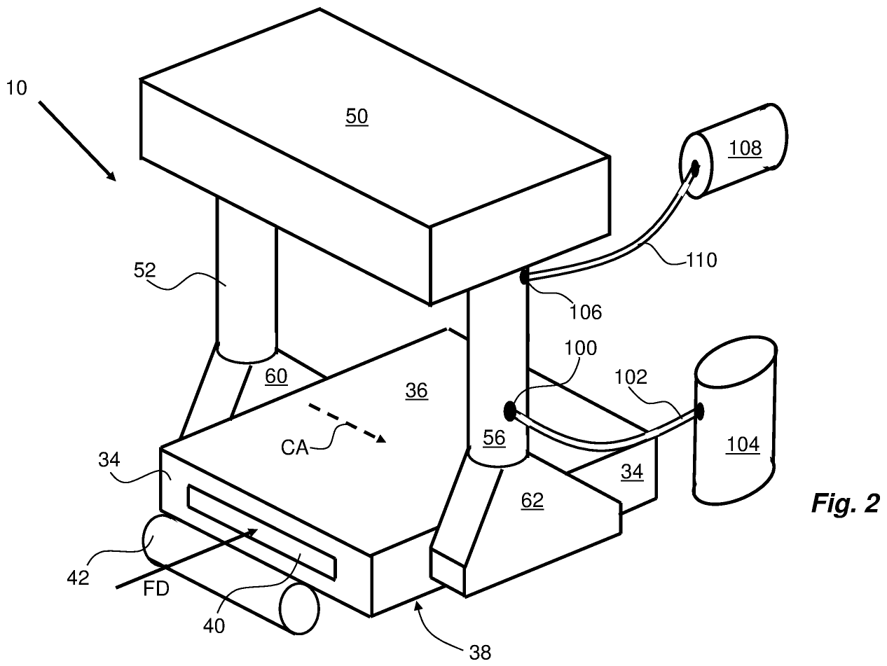

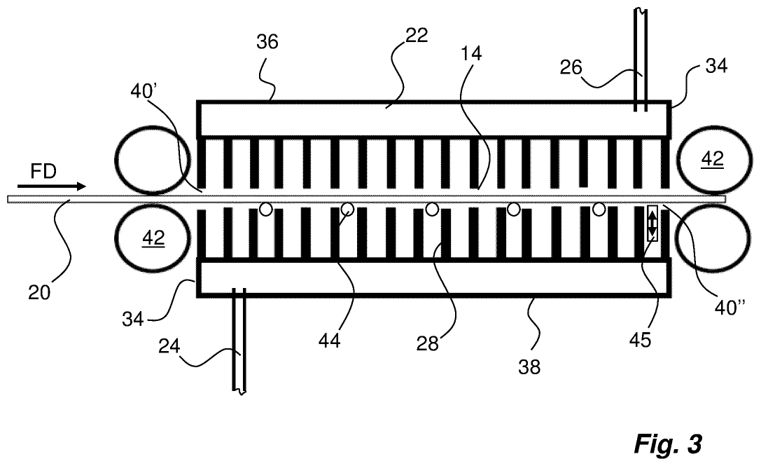

FIG. 1 shows an apparatus 10 for cooling components, such as an automobile component 20 by means of a cooling gas, e.g. air or any other gas, with or without steam. The apparatus comprises a confined space 14 arranged inside a cooling box 16 with an opening 18 for receiving a component 20 to be cooled. Preferably, the opening is re-closable. The cooling box 16 is preferably arranged with a plurality of heat sinks 22 inside the cooling box 16 for cooling the gas. The heat sinks 22 may be connected to cooling media via conduits 24, 26 such that a flow of cooling media is circulated through the heat sinks 22. The heat sinks 22 may also include cooling flanges 28, FIG. 3, increasing the overall cooling surface. It is obvious to a skilled person that the cooling efficiency will increase with an increased total cooling surface of the heat sink(s) 22, but that cooling will have effect also with a small cooling surface of only one heat sink 22. The apparatus 10 further includes at least one infra sound pulsator 30 and 32 arranged to provide an infra sound into said cooling box 16 to improve heat exchange between the cooling gas and a cooling surface of the at least one heat sink 22, as well as between the cooling gas and the component 20 to be cooled.

FIGS. 2 and 3 disclose schematically an example of an apparatus with a cooling box 16. The cooling box 16 is generally rectangular with four side walls 34, a top 36 and a bottom 38, forming a confined space 14. In one of the side walls a first opening 40′ is arranged, comprised of at least one elongate aperture, i.e. a slit shaped opening, arranged to receive a steel blank 20 or the like sideways into the confined space 10 of the cooling box 16. Also, the cooling box 16 may be provided with a second such opening 40″, where the two openings 40′, 40″ preferably are arranged opposed to each other on the cooling box 16, as seen in FIG. 3, such that the object to be cooled may be entered at one side of the cooling box 16 and taken out, after cooling, at the opposite side of the cooling box 16. This embodiment is hence specifically adapted to efficient cooling of blanks, such as metal sheets. The openings 40′, 40″ may be provided with flexible curtains or swingable doors (not shown) arranged to cover the openings but allow entry and/or exit of metal blanks. Such curtains or doors are arranged in order to minimise sound pollution and to keep a standing wave of infra sound as intact as possible inside the confined space 14 so as to maximise the cooling effect.

As illustrated in FIGS. 2 and 3, guide elements 42 may be arranged at each opening 12, to guide a component 20, such as an automobile component, between them. In the shown embodiment the guide elements 42 consist of conveyer rolls arranged to receive and guide blanks between them. As an alternative to conveyer rolls any surface which allows hot metal blanks to slide upon them may be provided, preferably combined with an apparatus for conveying said metal blanks through the confined space 14 of the cooling box 16. Also, conveyer rolls 44 or any other type of guide elements may be arranged inside the cooling box, FIGS. 1 and 3. Obviously, conveyer rolls or other types of guide elements need to be arranged at even intervals at distances from each other that is smaller than the length of the component 20 to be cooled. Further, the cooling box may be arranged with stop elements 45, against which the component 20 may abut so as to stop the movement for a cooling process. When the component is cooled to the desired temperature, the stop element 45 may be moved out of contact so that the component may be conveyed to a subsequent handling station. The cooling box shown in FIGS. 2 and 3 is further arranged with at least one heat sink 22 or the like cooling device. In order to increase the efficiency of the heat sink, cooling flanges 28 may be provided. As with the embodiment shown in FIG. 1, cooling conduits 24, 26 are preferably arranged to provide a cooling fluid, e.g. water, to cool said heat sinks 22.

An infra sound generator unit 50 is provided, FIGS. 1 and 2, having a first infra sound pulsator 30 connected to the cooling box 16 via a first resonator conduit 52, wherein the first infra sound pulsator 30 is arranged at a first outer end 54 of said first resonator conduit 52. The infra sound generator unit 50 is further arranged with a second infra sound pulsator 32 that is connected to the cooling box 16 via a second resonator conduit 56, said second infra sound pulsator 56 being arranged at a second outer end 58 of said second resonator conduit 56. The first and second resonator conduits 52 and 56 may be tubular as seen in FIG. 2, having substantially the same cross section along their whole length. They may however include passages of varying cross sections. A transition from one cross-sectional area to another cross-sectional area may be called a diffuser. In the shown embodiment of FIG. 1 such diffusers are arranged both at the outer ends 54 and 58, respectively, of the first and second resonator conduits 52 and 56, and at the transition 60 and 62 between the resonator conduits 52, 56 and the confined space 14 of the cooling box 16. The tubular resonators conduits 52, 56 may be bent or straight. As seen from the embodiments in FIGS. 1 and 2 and in particular from the arrows in FIG. 2, it is apparent that the pulsed cooling air CA is moving generally transversally to the feeding direction FD of the article to be cooled and in particular over and under the article.

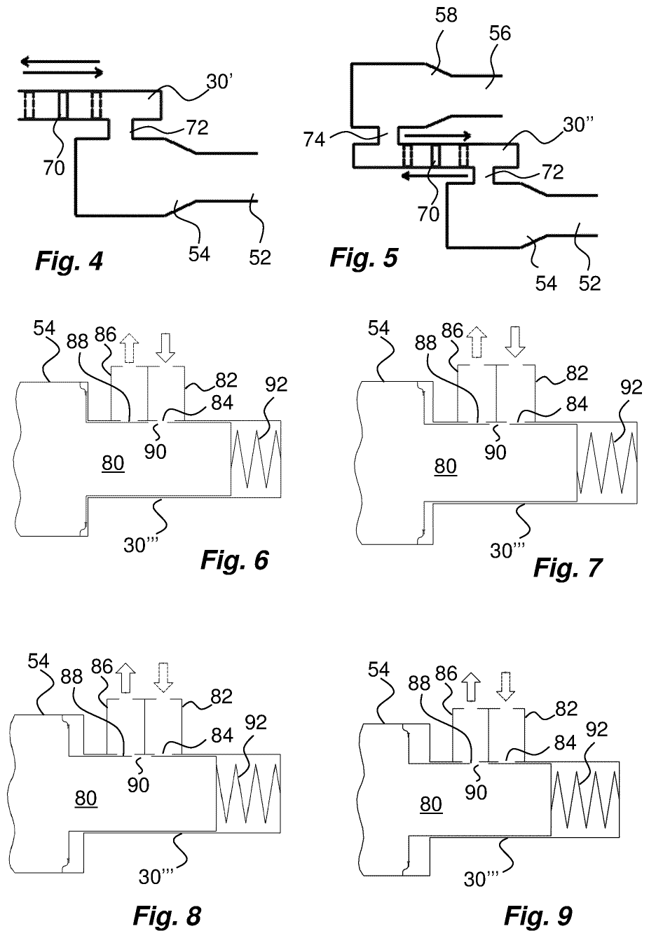

In FIGS. 4-9 three different types of pulsators are shown. An infra sound pulsator 30, 32 may be a P-pulsator or a S-pulsator. A P-pulsator is pulsator that pumps in air pulses and a S-pulsator is a pulsator that pumps out or releases air pulses. A pulsator that alternatively pumps in or pumps out air pulses is called a PS-pulsator. Either one P-pulsator and one S-pulsator is arranged at opposite ends of the system, or a PS-pulsator is arranged at both ends. The pulsators at opposite ends need to be synchronized with each other such that the standing sound wave may be withheld between the pulsators. Normally, this synchronization is set by allowing the pulsators to swing in the natural pace governed by the standing sound wave and to enhance the movement by the addition of a force in the direction of said natural pace.

In FIG. 4, a first type of PS pulsator 30′ is shown. A piston 70 that moves back and forth inside a cylinder is arranged to act as a PS-pulsator. The shown pulsator 30′ is connected with a conduit 72 at a first outer end 54 of the first tubular resonator conduit 52. Preferably a corresponding PS-pulsator is provided at the opposite end at the second outer end 5 of the second tubular resonator conduit 7. The opposed PS-pulsators are arranged to work out of phase with each other such that one of them is at its innermost position when the other is at its outermost position. With the interaction the pulsators will be a half wavelength out of phase with respect to each other. Thereby a standing wave a half wavelength will be produced between the respective outer ends 54 and 58 of the tubular resonator conduits 52 and 56, respectively.

In FIG. 5, an alternative pulsator 30″ is shown, which pulsator is connected to both the first outer end 54 of the first resonator conduit 52 via conduit 72 and the second outer end 58 of the second resonator conduit 56 via conduit 74. With this configuration the piston 70 will provide a pressure into one outer end 54, 58 of a resonator conduit and simultaneously release pressure from the outer end 58, 54 of the other resonator conduit.

In FIGS. 6-9 a specific type of pulsator 30′″ for producing sound waves of high intensity is shown in different modes. The pulsator 30′″ includes a spring biased piston 80. The pulsator 30′″ includes an inlet chamber 82 with a valve inlet opening 84 and an outlet chamber 86 with a valve outlet opening 88. The spring biased piston 80 includes a piston port 90, which is arranged to face the valve inlet opening 84 and the valve outlet opening 88. The inlet chamber 82 is connected to a continuous pressure source (not shown) and the outlet chamber 86 is connected to a continuous negative pressure source (not shown).

As the spring biased piston 80 moves the piston port 90 alternatively connects the inlet chamber 82 via the valve inlet opening 84 to the inside of the piston 80, or the outlet chamber 86 via the valve outlet opening 88 to the inside of the piston 80. The connection between the valve inlet opening 84 and the inlet chamber 82 to the inside of the piston 80 is governed by the position of the spring biased piston 80. The openings are arranged such that only one of the valve inlet opening 84 and the valve outlet opening 88 is in line with the piston port 90 at a time.

In FIG. 6 the spring biased piston 80 is in its innermost position, in which a spring 92 that holds the spring biased piston 80 is in its most compressed state. From this position the spring 92 will act on the spring biased piston 80 so as to push it inwards to compress the air in the outer end 54 of the first resonator conduit 52 so as to create a pulse in the first resonator conduit 52, past the cooling box 16 and through the second resonator conduit 56.

In the position shown in FIG. 6 the piston port 90 is positioned in line with the valve inlet port 84 to connect inlet chamber 82 to the inside of the piston 80 so as to further increase the pressure in the resonator conduits and to build on the standing wave in said resonator conduits.

In the position shown in FIG. 7 the piston 80 has moved from its outermost position and is still accelerating in its movement inwards towards the resonator conduit so as to further compress the air in said resonator conduit. The piston port 90 is still positioned at least partly in line with the valve inlet port 84 to connect inlet chamber 82 to the inside of the piston 80 so as to further increase the pressure in the resonator conduits

In the position shown in FIG. 8 the piston 80 has moved to a position where the spring 92 has started to act outwards, i.e. in the opposite direction of the movement of the piston 80, so as to decelerate the movement of said piston 80. Further, at substantially the same position as the un-biased position of the spring is passed, the piston port 90 passes from connection to the valve inlet port 84 into connection to the valve outlet port 88, such that air will be sucked from the inside of the piston 80 via the valve outlet port 88 into the outlet chamber and on to the negative pressure source (not shown).

In the position shown in FIG. 9 the piston 80 has moved to its innermost position, from which position it will return and start moving outwards. The spring 92 is extended, acting to pull the piston 80 outwards so as to relieve the pressure in the resonator conduits and the action is enhanced in that the piston port 90 is connected to the valve outlet port 88, such that air will be sucked from the inside of the piston 80 towards the outlet chamber 86.

From the position shown in FIG. 9 the piston 80 will move reversely towards the position shown in FIG. 6 via the positions shown in FIGS. 8 and 7, respectively. The pulsator 30′″ is hence self-regulating in that the standing wave of half a wavelength will be produced and withheld by means of the pulsator 30′″ and a corresponding pulsator at the opposite end of the resonator conduits, wherein the other pulsator will be self-regulated to lie one half-length out of phase with the first pulsator 30′″.

As illustrated in FIGS. 1 and 2 the first and second resonator conduits 52 and 56 are preferably of similar lengths and a standing wave is produced from the first infra sound pulsator 30 to the second infra sound pulsator 32, wherein the first infra sound pulsator 30 is arranged to produce a standing wave of which half a wavelength corresponds to a combined length of the first and second resonator conduits 52 and 56 and the cooling box 16. Hence, the first and second pulsators 30 and 32 are out of phase with each other with half a wavelength.

The wavelength of the standing wave is, as is apparent from the above, dependent of the length of the system, i.e. the length between the first and second pulsator 30 and 32, respectively. Preferably, the frequency is 50 Hz or less, which would yield a sound with a wavelength of 6.8 metre and hence demand a length of 3.4 metre between the pulsators. The cooling effect will however increase with a lower frequency and in a specific embodiment the length between the pulsators is about 8.5 metre which will yield a sound wave of a frequency of about 20 Hz. To achieve a very high cooling efficiency the frequency could be kept at 20 Hz or below, preferably 16 Hz, and the combined length of the first and second resonator conduits 6 and 7 and the cooling box 11 should therefore be about 8.5 metre or more to obtain said very high cooling efficiency.

The infra sound cooling device of the invention may further comprise at least one inlet 100 for protective gases, FIG. 2. According to one embodiment, the inlet is placed in one or both of the resonator conduits 52, 56. The inlet 100 may be arranged as a nozzle connected to a conduit 102, which in turn is connected to a source of protective gas 104, wherein the gas, possibly pressurized, may be supplied or injected into the resonator conduits 52, 56. The type of gas may preferably be inert gases that do not react chemically with their environment and that will provide an oxygen-free atmosphere inside the cooling box. One of the most used gases is nitrogen that is cost-effective and non-harmful to the environment. It is however to be understood that other gases or mixtures of gases may be used for the same purpose. For instance, there might be gases and mixtures thereof that display increased heat transfer properties that might be beneficial for the cooling process. For instance, methanol may be added in the gas mixture. Further, a particle catcher 106 may be arranged to the resonator conduits 52, 56. The particle catcher 106 will ensure that any particles from the treated and cooled components inside the cooling box are prevented from entering the pulsators. The particle catcher is preferably some sort of nozzle unit connected to a vacuum source 108 via suitable conduits 110.

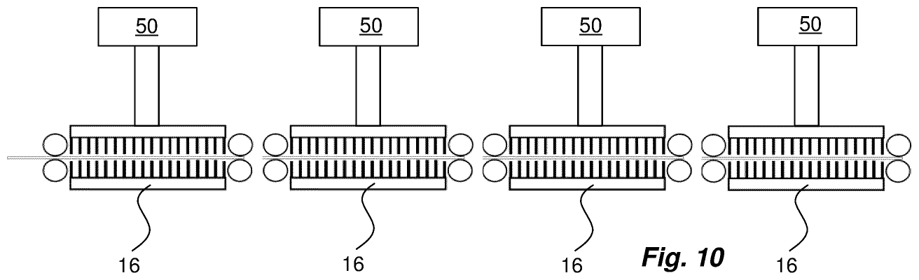

Further, for some applications and for some types of components to be treated, several cooling boxes may be placed in succession, as seen in FIG. 10. This may for instance be if the component is much longer than one cooling box 16. The component or components may then be conveyed through several cooling boxes 16 for obtaining the desired cooling temperature. In this regard, the conveying speed may be changed during the transfer of one elongated component. This is due to that the rear end of the component is outside and untreated which means that it will be exposed to oxidising environment longer than the front end that enters a cooling box immediately. In this scenario it might be advantageous to increase the conveying speed in the beginning and then reduce the speed in order to reduce the overall cooling time and in particular reduce the time that the rear part of the component is outside the cooling box(-es). Even though the embodiment of FIG. 10 shows four cooling boxes, it is to be understood that less or more cooling boxes may be used in order to obtain the correct cooling temperature for subsequent treatment steps. Further, the figure shows separate infra sound generator units for each cooling box but it is to be understood that one infra sound generator unit could have a capacity of handling several cooling units at the same time. It is also possible to put several cooling boxes in a larger housing and/or place them so close so that no special conveyor arrangements are needed between the cooling boxes.

Further, the process according to the invention is also beneficial to handling of thicker metal blanks, in the region of 4-7 mm thickness. These blanks are also conveyed from a heating unit such as a furnace to the cooling apparatus 10 wherein the metal blanks are cooled to temperatures that are more suitable when forming components in a forming step such as a press. Thus, with the cooling apparatus, also thicker metal blanks can be handled very effectively and with much reduced wear of the forming dies. Also, the cycle time is reduced due to shorter time period in the press for cooling. When handling thicker metal blanks, several cooling apparatuses may be used as described above in order to cool the blank as fast as possible before pressing.

It is to be understood that the embodiment described above and shown in the drawings is to be regarded only as a non-limiting example of the invention and that it may be modified in many ways within the scope of the patent claims.

1. A process for cooling a metal component, the process comprising the step of cooling said component in a confined space, said cooling involving cooling by means of a gas, the gas being cooled by heat exchange with a cooling surface of a heat sink inside said confined space, wherein a low frequency sound wave is provided into said confined space in order to improve heat exchange both between the gas and a cooling surface of the at least one heat sink, and between the gas and the metal component, characterised in that the cooling gas comprises at least one protective inert gas.

2. The process according to claim 1, wherein the cooling gas comprises a mixture of gases.

3. The process according to claim 1, wherein the cooling gas possesses as good as possible heat transfer properties.

4. The process according to claim 1, wherein the gas comprises nitrogen.

5. The process according to claim 1, wherein the gas is injected into the confined space.

6. The process according to claim 1, wherein the sound wave has a frequency that preferably is lower than 50 Hz, more preferably lower than 20 Hz.

7. The process according to claim 1, wherein the sound wave is provided from a first end of the confined space so as to propagate through the confined space and away at a second end of the confined space, opposite to said first end thereof.

8. The process according to claim 7, wherein components to be cooled in the confined space are conveyed from a first end to a second end in a direction generally transversal to the direction of the sound wave.

9. The process according to claim 1, wherein the components have a thickness in the region of 4-7 mm.

10. An apparatus for cooling a metal component by means of a gas, the apparatus comprising a cooling box forming a confined space and provided with an opening for receiving a metal component to be cooled, wherein at least one heat sink is provided inside the cooling box for cooling of the gas, and wherein the apparatus includes at least one infra sound pulsator arranged to provide an infra sound into said cooling box to improve heat exchange both between the gas and a cooling surface of the at least one heat sink, and between the gas and the metal component, characterised in at least one inlet in communication with said confined space, which inlet is connected to a source of protective inert gas.

11. The apparatus according to claim 10, wherein inner walls of the cooling box form part of the at least one heat sink, flexible cooling conduits being arranged to provide a cooling fluid to cool said heat sink.

12. The apparatus according to claim 10, wherein said at least one heat sink is arranged with cooling flanges.

13. The apparatus according to claim 10, wherein the opening of the cooling box is slit-shaped and adapted to receive a metal component to be cooled, said metal component having an elongate form, typically in the form of a plate, and wherein the apparatus includes at least one guide element adapted to guide said metal component into and/or out from said cooling box through said opening.

14. The apparatus according to claim 13, wherein a first and a second slit-shaped opening are arranged at opposite sides of the cooling box, and wherein the at least one guide element is adapted to guide said metal component into said cooling box through the first slit-shaped opening and out through the second slit-shaped opening.

15. The apparatus according to claim 12, wherein the guide element consist of a pair of conveyer rolls, which are arranged at each opening, said pair of conveyer rolls being arranged to guide a metal component between them.

16. The apparatus according to claim 15, characterised in that at least two cooling boxes are arranged in succession wherein a component to be cooled may be transferred from one cooling box to the subsequent.
